(19) United States
(12) Patent Application Publication
(10) Pub. No.: US 2011/0154651 A1
(43) Pub. Date: Jun. 30, 2011

(54) MULTI-FUNCTIONAL COAXIAL TERMINAL CONNECTION PLIERS

(76) Inventor: Jen-Kai Liu, Taipei Hsien (TW)

(21) Appl. No.: 12/647,554

(22) Filed: Dec. 28, 2009

(51) Int. Cl. H01R 43/00

(52) U.S. Cl. 29/750

(57) ABSTRACT

A multi-functional coaxial terminal connection pliers comprises a first handle has a handle portion and a combining portion; a second handle having a handle portion pivoted to the combining portion of the first handle; an interaction portion having one end pivoted to the combining portion of the first handle; a first sliding portion pivoted to another end of the interaction portion and having a screw hole; a second sliding portion pivoted to the first sliding portion and having a combining hole; a pressing head combining to the screw hole of the first sliding portion by passing though the combining hole of the second sliding portion; and a molding block firmly secured to the second handle; and the pressing head having at least two pressing sections. The pliers provides a molding block suitable for coaxial terminals of different sizes and has a simple structure and a lower manufacturing cost.

### FIELD OF THE INVENTION

The present invention relates to press-connection pliers, and particularly to a multi-functional coaxial terminal connection pliers which is suitable for coaxial terminals of different specifications.

### BACKGROUND OF THE INVENTION

In the prior press-connection tool for coaxial terminals of different kinds (such as F type coaxial terminal, or BNC coaxial terminal) or of the same kind, but different specifications (for example different lengths), different terminal press-connection tools are used. Although a detachable coaxial terminal press-connection tool is suitable for coaxial terminals of different kinds or different specifications, the coaxial terminals have many different specifications and kinds. Thus, many different kinds of pressing tools are needed to be prepared for different specific coaxial terminals. As a result, not only the cost is high, but also it is inconvenient to store so many terminal pressing tools.

In Taiwan Patent No. M317696, a press-connection pliers is disclosed, which is used to limit a cable and to combine the cable to a connector. The pliers include a seat, a pushing portion, a clamping seat, a pressing portion, etc. The seat has a receiving space for receiving the pushing portion. The pushing portion is replaceable by using an adjusting button to adjust a linkage. The linkage is connected to a pressing portion. When the pressing portion is pressed, the linkage is pushed to drive the sliding seat to reciprocally move within the receiving space. Thus a resisting body of the sliding seat slides reciprocally with respect to the clamping seat. Another side of the sliding seat is installed with the clamping seat in the receiving space. The clamping seat has a wire groove. When a cable passes through the groove, it will buckle to the groove by using a rotation buckle so that the cable is limited. It is convenient to combine with a signal connector at the sliding seat. Thus, the cable can be assembled to the connector quickly.

In Taiwan Patent No. M244637, a compound coaxial terminal press-connection pliers is disclosed. It has a first handle which is installed to a molding block. The molding block has at least two pressing sections for changing portions in turning direction. A second handle is used to drive a pressing head to press the molding block to displace so as to connect a terminal and a wire in the pressing section after turning. By the function of turning and changing position of two sets of pressing sections, the pliers can press-connect two sets of terminals and wires of different specifications.

In Taiwan Patent No. M271301, a press-connection pliers is disclosed. The pliers includes a base, a turning handle, and a resisting rod. One side of the base has a seat and another side far away from the seat is installed with a resisting portion. One side of the resisting portion near the turning handle is an adjusting element pivoted with rotary means. The adjusting element has a receiving groove resisting against a coaxial joint. A channel is formed between the base and the resisting portion. The adjusting element can rotate axially in the resisting portion. The rotation handle is installed with a pivoted portion for pivoting the resisting rod. The pivot portion of the rotation handle is combined to the seat of the base. When the rotation handle rotates, the resisting rod is driven to move reciprocally in the channel. When the pressing head is installed with a coaxial joint, the adjusting element is driven to have a size matching the coaxial joint resisting thereto. No pliers of different size is necessary to be prepared. The same pressing pliers can be used to operate a coaxial joint of different size. The operation of the pressing pliers is easy and the pressing pliers can be used widely.

In U.S. Pat. No. 7,152,309 and U.S. Pat. No. 6,591,487, a compound coaxial terminal pressing pliers and a hard cable press-connection tool are disclosed, respectively. In U.S. Pat. No. 7,210,327, a press-connection tool is disclosed. Besides, in U.S. Pat. No. 6,948,234, a terminal pressing-connection tool is disclosed. However all above mentioned prior arts, they have complicated structures.

Thus, all prior coaxial press-connection tools have some defects necessary to be improved.

### SUMMARY OF THE INVENTION

The object of the present invention is to provide a multi-functional coaxial terminal connection pliers which provide a molding block suitable for coaxial terminals of different sizes.

Another object of the present invention is to provide a multi-functional coaxial terminal connection pliers which has a simple structure and a lower manufacturing cost.

To achieve above object, the multi-functional coaxial terminal connection pliers of the present invention comprises a first handle has a handle portion and a combining portion; a second handle having a handle portion pivoted to the combining portion of the first handle; an interaction portion having one end pivoted to the combining portion of the first handle; a first sliding portion pivoted to another end of the interaction portion and having a screw hole; a second sliding portion pivoted to the first sliding portion and having a combining hole; a pressing head combining to the screw hole of the first sliding portion by passing though the combining hole of the second sliding portion; and a molding block firmly secured to the second handle; and the pressing head having at least two pressing sections.

The multi-functional coaxial terminal connection pliers of the present invention has a simple structure. The user only needs to apple less power. The molding block of the present invention has at least two pressing sections for coaxial terminals of different specifications. Thereby the cost for press-connection tool is saved and it is convenient in storage.

### BRIEF DESCRIPTION OF THE DRAWINGS

FIG. 1 is an explosive schematic view of the first embodiment of the present invention.

FIG. 2 is a schematic view of the first embodiment about the combination of the present invention.

FIG. 3 is a schematic view of the first embodiment of the present invention before connection.

FIG. 4 is a schematic view of the first embodiment of the present invention after connection.

FIG. 5 is an explosive schematic view of the second embodiment of the present invention.

FIG. 6 is an assembled view of the second embodiment about the combination of the present invention.

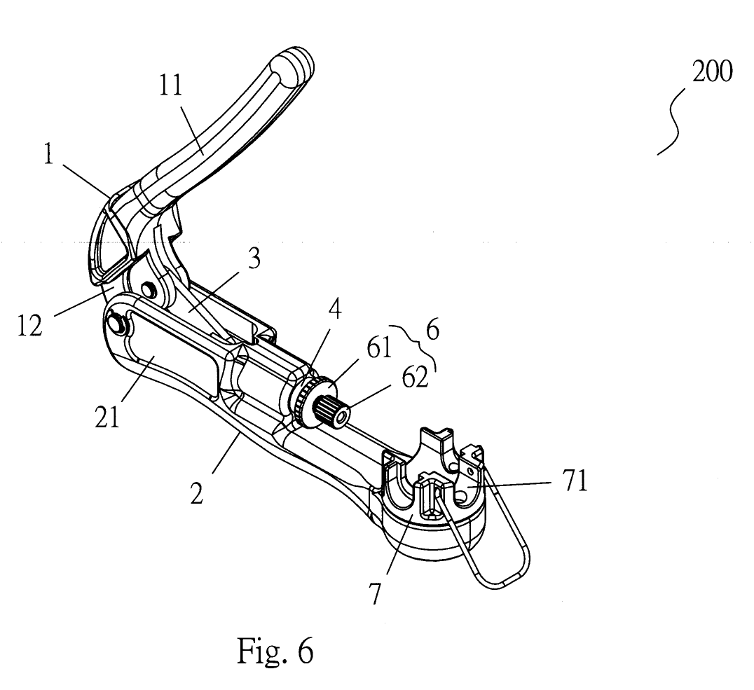

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

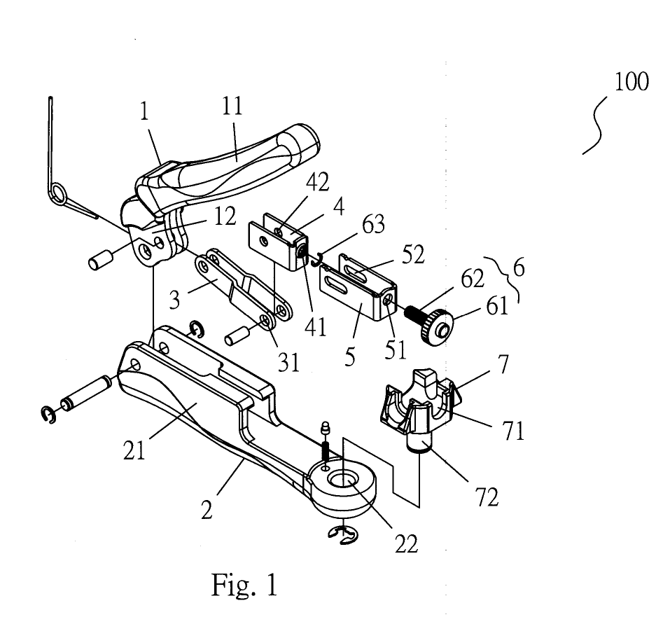

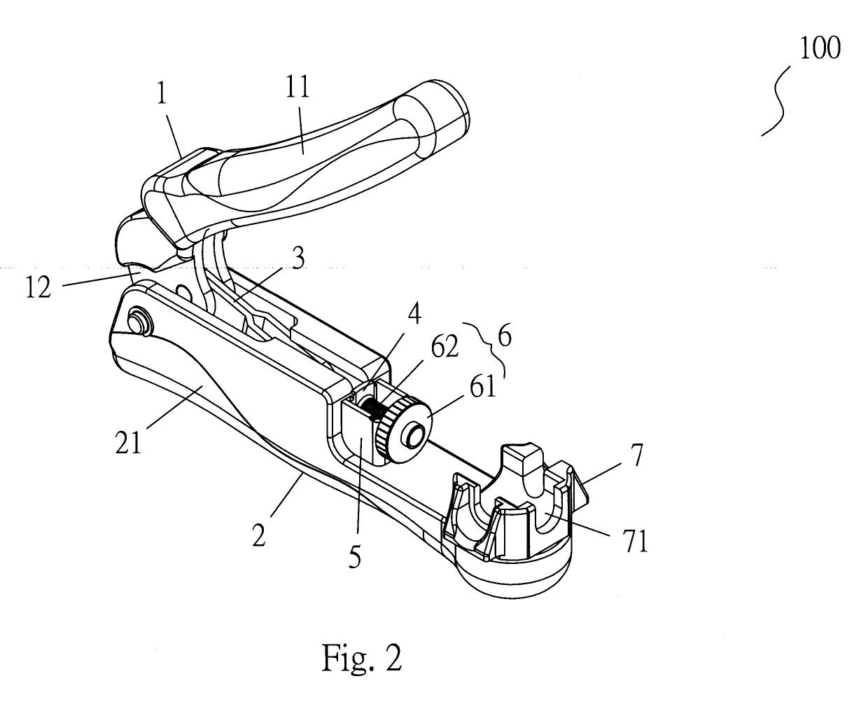

Referring to FIGS. 1 and 2, the first embodiment of the present invention is illustrated. As illustrated in the drawing, the multi-functional coaxial terminal connection pliers 100 of the present invention includes a first handle 1, a second handle 2, an interaction portion 3, a first sliding portion 4, a second sliding portion 5, a pressing head 6 and a molding block 7.

The first handle 1 has a first handle portion 11 and a combining portion 12. The second handle 2 has a second handle portion 21 and a molding block combining hole 22. The second handle portion 21 of the second handle 2 is pivotally connected to the combining portion 12 of the first handle 1. Thereby the first handle 1 and the second handle 2 can move away or closer.

The interaction portion 3 has one end pivotally connected to the combining portion 12 of the first handle 1 and another end having a combining hole 31.

The first sliding portion 4 has a screw hole 41 and a combining hole 42.

The second sliding portion 5 has a combining hole 51 and a limiting groove 52.

The combining hole 31 of the interaction portion 3 is corresponding to the combining hole 42 of the first sliding portion 4. A pivot shaft passes through the limiting groove 52 of the second sliding portion 5 to the combining hole 31 of the interaction portion 3 and then to the combining hole 42 of the first sliding portion 4 so that the interaction portion 3, the first sliding portion 4 and the second sliding portion 5 are pivotally combined.

The pressing head 6 has a pressing portion 61 and a screw rod 62. The screw rod 62 passes through the combining hole 51 of the second sliding portion 5 to screw to the screw hole 41 of the first sliding portion 4. Then a C buckle 63 is installed to the second sliding portion 5 and is buckled to the screw rod 62 of the pressing head 6. Thereby when the pressing head 6 rotates, the second sliding portion 5 will move by the driving of the pressing head 6. Besides, since the second sliding portion 5 is pivoted to the combining hole 31 of the interaction portion 3 by a pivot shaft passing through the limiting groove 52 of the second sliding portion 5 to combining hole 31 of the interaction portion 3 and the combining hole 42 of the first sliding portion 4. Thus, the second sliding portion 5 will not release as it is driven by the pressing head 6.

The molding block 7 is firmly secured to the molding block combining hole 22 of the second handle 2. The molding block 7 has a plurality of pressing section 71 for receiving coaxial cables of different specifications.

In this embodiment, the second handle 2 is formed with a molding block combining hole 22, and the molding block 7 has a combining portion 72 which is combined to the molding block combining hole 22 of the second handle 2 so that the molding block 7 is combined to the second handle 2. However a post can be used to replace the molding block combining hole 22 and the combining portion 72 of the molding block 7 can be replaced by a hole which is combined to the post of the second handle 2 so that the molding block 7 is combined to the second handle 2.

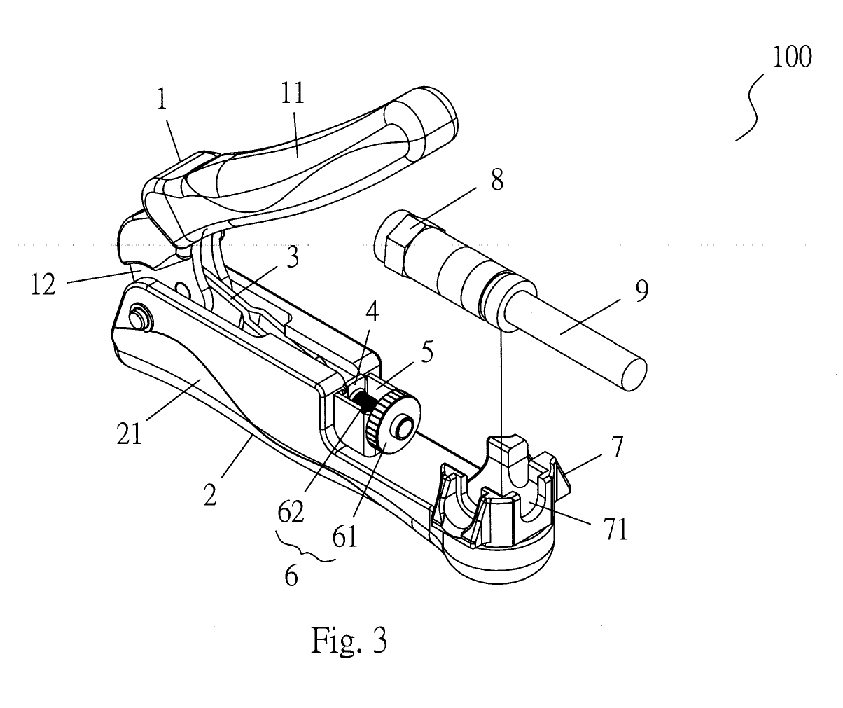

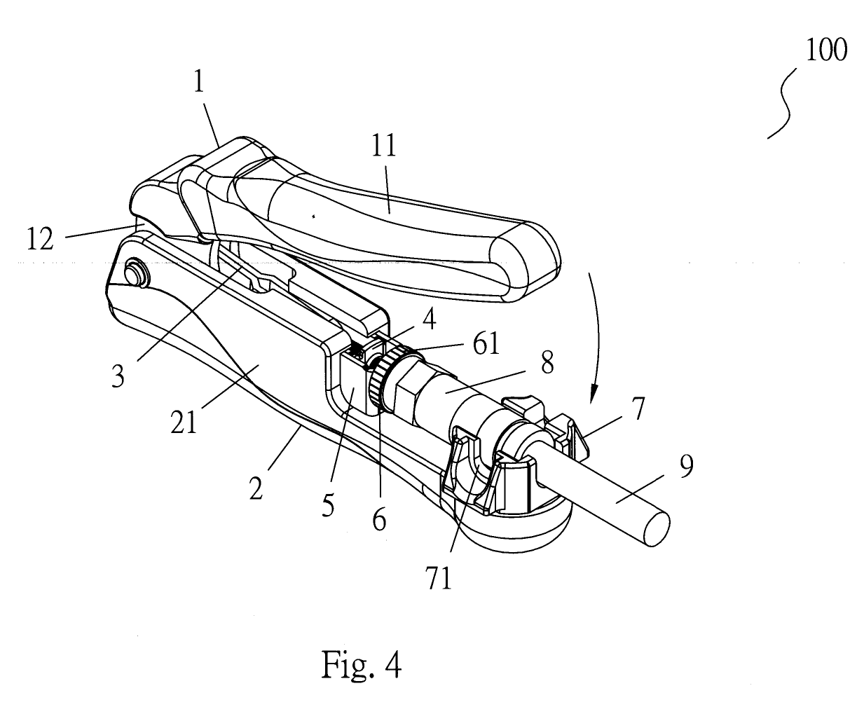

Referring to FIGS. 3 and 4, FIG. 3 is a schematic view showing an operation before press-connection and FIG. 4 is a schematic view showing an operation after press-connection. As illustrated in the drawing, when it is desired to combine a coaxial terminal 8 to a coaxial cable 9, the user expand the handle portion 11 of the first handle 1 upwards, and meanwhile, the interaction portion 3 pivotal to the first handle 1 will be driven by the first handle 1 to move upwards. Another end of the interaction portion 3 moves toward the handle portion 21 of the second handle 2.

When the interaction portion 3 moves by the driving of the first handle 1, the first sliding portion 4 pivoted to the interaction portion 3 will move by the driving of the interaction portion 3 so as to drive the pressing head 6 which is screwed to the first sliding portion 4. Then the pressing head 6 will drive the second sliding portion 5 to move. Then the user couples the coaxial terminal 8 to the pressing portion 61 of the pressing head 6 and the coaxial cable 9 is placed to the pressing section 71 of the molding block 7.

When the user locates the coaxial terminal 8 and the coaxial cable 9 to the pressing head 6 and the pressing section 71, respectively, the user presses the handle portion 11 of the first handle 1 toward the handle portion 21 of the second handle 2. Then the interaction portion 3 is driven by the first handle 1 to move downwards. Another end of the interaction portion 3 moves toward the front end of the second handle 2.

When the interaction portion 3 moves by the driving of the first handle 1, the first handle 1 pivoted to another end of the interaction portion 3 will move forwards by the driving of the interaction portion 3. The first sliding portion 4 screwed to the pressing head 6 will drive the second sliding portion 5 to move forwards with the movement of the first sliding portion 4 so that the coaxial terminal 8 is combined to the coaxial cable 9 so as to complete the operation of press-connection.

Besides, since the molding block 7 has a plurality of pressing sections 71, when the user desires to connect coaxial cables 9 of different specifications, the user can rotate the molding block 7 so as to select a desired pressing section 71.

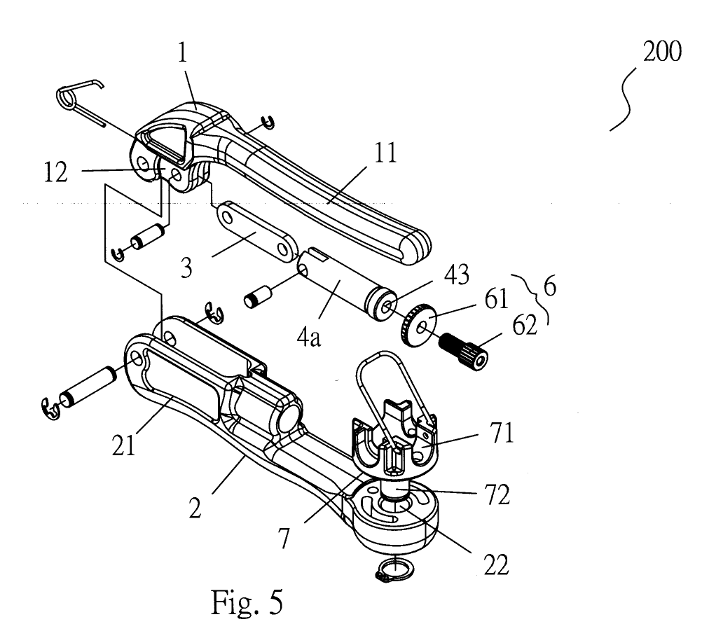

With referring to FIGS. 5 and 7, the second embodiment of the present invention is illustrated. It is illustrated that multi-functional coaxial terminal connection pliers 200 of the present invention includes a first handle 1, a second handle 2, an interaction portion 3, a sliding portion 4a, a pressing head 6, and a molding block 7.

The first handle 1 has a first handle portion 11 and a combining portion 12. The second handle 2 has a second handle portion 21 and a molding block combining hole 22. The second handle portion 21 of the second handle 2 is pivotally connected to the combining portion 12 of the first handle 1. Thereby the first handle 1 and the second handle 2 can move away or closer.

The interaction portion 3 has one end pivotally connected to the combining portion 12 of the first handle 1. The sliding portion 4a is pivoted to another end of the interaction portion 3. The sliding portion 4a has a screw hole 41 for combining with the pressing head 6. The pressing head 6 has a pressing portion 61 and a screw rod 62. The pressing portion 61 of the pressing head 6 serves to couple with a coaxial terminal. The screw rod 62 is screwed to the screw hole 43 of the pressing portion 4a. The molding block 7 is firmly secured to the molding block combining hole 22 of the second handle 2. The molding block 7 has a plurality of pressing sections 71 for receiving coaxial cables 9 of different specifications.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-4. (canceled)

5. A multi-functional coaxial terminal connection pliers, comprising:
a first handle has a handle portion and a combining portion;
a second handle having a handle portion pivoted to the combining portion of the first handle;
an interaction portion having one end pivoted to the combining portion of the first handle;
a sliding portion having one end pivoted to another end of the interaction portion and another end of the sliding portion having a screw hole;
a pressing head combined to the screw hole of the sliding portion; and
a molding block firmly secured to the second handle; and the molding block having at least two pressing sections.

6. The multi-functional coaxial terminal connection pliers as claimed in claim 5, wherein second handle includes a combining hole and the molding block is combined to the combining hole of the second handle.

7. The multi-functional coaxial terminal connection pliers as claimed in claim 5, wherein the second handle has a post and the molding block has a recess which is combined to the post of the second handle so that the molding block is combined to the second handle.

8. The multi-functional coaxial terminal connection pliers as claimed in claim 5, wherein the pressing head has a pressing portion and a screw rod; the pressing portion serves to receive a coaxial terminal and the screw rod passes through the combining hole of the second handle to screw to the screw hole of the sliding portion.
